(19) United States
(12) Patent Application Publication
(10) Pub. No.: US 2023/0047062 A1
(43) Pub. Date: Feb. 16, 2023

(54) SYSTEM AND METHOD FOR DETERMINING MARKET SHARE OF AN ORGANIZATION

(71) Applicant: Flipkart Internet Private Limited, Bengaluru (IN)

(72) Inventors: Mayank KANT, Bangalore (IN); Sneh GUPTA, Khargone (IN); Aditya KUMAR, Patna (IN); Praneet MISHRA, Bangalore (IN); Syed Atif UMAR, Bangalore (IN); Ravi Vijaya RAGHAVAN, Bangalore (IN)

(73) Assignee: Flipkart Internet Private Limited, Bengaluru (IN)

(21) Appl. No.: 17/885,134

(22) Filed: Aug. 10, 2022

(30) Foreign Application Priority Data
Aug. 11, 2021 (IN) 202141036284

(51) Int. Cl. G06Q 10/06; G06Q 30/02

(52) U.S. Cl. CPC G06Q 10/06375; G06Q 10/06315; G06Q 30/0201

(57) ABSTRACT

A system and method for determining market share of an organization. The method encompasses receiving, at least one of a voice of customer data, an internal data of the organization and an external data. The method thereafter leads to determining, one or more set of target features based on at least one of the voice of customer data, the internal data of the organization and the external data. Further the method comprises generating, one or more pre-trained dataset based at least on the one or more set of target features. The method thereafter encompasses receiving, at least one of a first set of feature constraints and a second set of feature constraints. Further the method comprises determining, the market share of the organization based at least on the one or more pre-trained dataset, the first set of feature constraints and the second set of feature constraints.

### TECHNICAL FIELD

The present invention generally relates to decision science and more particularly to systems and methods for determining market share of an organization.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Market share of an organization (i.e. relative revenue performance of an organization) in its respective sector, is an important metric to track as it helps to identify competition strategies for different categories of products/services, find out whitespaces for category businesses, provide critical input to future business planning and explain various market forces and overall macroeconomic impact etc. Therefore, the market share plays a significant role in growth of the organization and it is important to predict the market share of the organization in its respective sector.

Generally, the market share of an organization is predicted based on manually prepared market share reports. For instance in an e-commerce space to predict the market share of an organization, 3rd party market share reports at business unit (BU) level are obtained from agencies doing competitive research. These market share reports are triangulated using sample user feedback through SMS crawls/online surveys etc. Thereafter, based on these market share reports, interim market share report are prepared and shared with business teams of the organization. Also, thereafter people of the organization who handle the relationship with a portfolio of brands, check with the brands on relative sales of key brands across channels. Further, corrections are made in the interim market share report basis the relative sales of the key brands across channels to prepare a final market share report. Therefore, such currently known market share prediction solutions majorly involves manual intervention and the entire process of predicting the market share takes a lot of time and efforts. Also, in said solutions there is no intermediate view to course correct and such solutions fails to help in taking corrective actions. The current market share reporting solutions doesn't explain the reasons of drop/increase and there is no forecast available. Also, some other known arts provides a solution to predict relative revenue performance based on a data limited to public companies and therefore fails to predict market share for private companies/organizations. Also, these solutions are limited to provide Gross Merchandise Value (GMV) comparison between competitors at platform/organization level and/or at business unit (BU) level, and fails to provide the GMV comparison between the competitor organizations at a granular level such as at BU×Tier level.

Therefore, there are a number of limitations of the current market share prediction solutions and there is a need in the art to provide a method and system for efficiently and effectively determine the market share of an organization.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for determining market share of an organization. Also, an object of the present invention is to determine market share of an organization more efficiently and effectively as compared to prior known solutions. Another object of the present invention is to predict a market share of public as well as non-public (private) organizations. Also an object of the present invention is to use data from plurality of data sources such as including but not limited to social media, 3rd party survey and/or internal data of one or more companies to predict Market Share for the one or more companies. Another object of the present invention is to provide a GMV comparison between competitors at, at least one of a platform/organization level, a business unit (BU) level and a BU along with metro level. Further an object of the present invention is to predict a view of market share of an organization at a regular interval to help in taking corrective actions to change one or more input levers like Pricing, Marketing, Traffic shaping etc. Another object of the present invention is to provide a solution that can help in understanding key parameters that can affect the movement of market share in order to further make the right trade-offs to augment the market share. Further an object of the present invention is to provide a solution which can create a relation between different internal parameters associated with an organization which can impact market share. Also, an object of the present invention is to provide a solution that can help in demand planning for a target market share based on input parameters' targets for a future period. Further an object of the present invention is to provide a solution that can help in understanding a market size of the different categories in order to further understand category growth rates and macro factors leading to it. Another object of the present invention is to provide a solution that can help in understanding a Market share helped in Demand forecasting and correct target setting for categories with an aspiration of a certain market share. Yet another object of the present invention is to provide a market share prediction solution that can provide festive period planning and mid-event corrective actions based on movement of market share of an organization.

Furthermore, in order to achieve the aforementioned objectives, the present invention provides a method and system for determining market share of an organization.

A first aspect of the present invention relates to the method for determining market share of an organization. The method encompasses receiving, at a transceiver unit, at least one of a voice of customer data, an internal data of the organization and an external data. The method thereafter leads to determining, by a processing unit, one or more set of target features based on at least one of the voice of customer data, the internal data of the organization and the external data. Further the method comprises generating, by the processing unit, one or more pre-trained dataset based at least on the one or more set of target features. The method thereafter encompasses receiving, at the transceiver unit, at least one of a first set of feature constraints and a second set of feature constraints. Further the method comprises determining, by the processing unit, the market share of the organization based at least on the one or more pre-trained dataset, the first set of feature constraints and the second set of feature constraints.

Another aspect of the present invention relates to a system for determining market share of an organization. The system comprises a transceiver unit, configured to receive at least one of a voice of customer data, an internal data of the organization and an external data. The system further comprises a processing unit, configured to determine one or more set of target features based on at least one of the voice of customer data, the internal data of the organization and the external data. Thereafter the processing unit is configured to generate, one or more pre-trained dataset based at least on the one or more set of target features.

Also, the transceiver unit is further configured to receive, at least one of a first set of feature constraints and a second set of feature constraints. Further, the processing unit is configured to determine, the market share of the organization based at least on the one or more pre-trained dataset, the first set of feature constraints and the second set of feature constraints.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for determining market share of an organization, in accordance with exemplary embodiments of the present invention.

FIG. 2 illustrates an exemplary method flow diagram [200], for determining market share of an organization, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a transceiver unit, a processing unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for efficiently and effectively determining market share of an organization. More particularly, to efficiently and effectively determine the market share of the organization the present invention encompasses use of a data from various data sources such as a voice of customer data, an internal data of the organization and an external data. The voice of customer (VoC) data is a user feedback data generated based on a set of social media posts related to one or more organizations. The internal data of the organization comprises a data associated with said organization and such data may not be available in public domain. The external data comprises a data determined based on one or more third party data sources. Furthermore, the present invention further encompasses determining one or more required (target) features based on at least one of the voice of customer data, the internal data of the organization and the external data. Once the target feature(s) are determined, the present invention encompasses determining one or more pre-trained dataset based on the target feature(s). Further the present invention determines the market share of the organization using the one or more pre-trained dataset, a first set of feature constraints and a second set of feature constraints, wherein each of the first set of feature constraints and the second set of feature constraints comprises one or more feature constraints. In an implementation the feature constraint(s) of the first set of feature constraints are different from the feature constraint(s) of the second set of feature constraints.

Therefore, based on the implementation of the features of the present invention the market share of an organization is predicted effectively and efficiently. Also, the present solution provides a technical effect by providing a solution that can automatically determine market share of public and/or private organizations using data received from various data sources. The present solution also provides a technical advancement over prior known solutions of market share prediction by eliminating the manual efforts in predicting the market share and by providing GMV comparison between competitors at more granular level as compared to the known solutions. Furthermore, the present solution also provides a technical advancement over prior known solutions of market share prediction by determining market share of an organization based on a creating a relation between different internal parameters which can impact market share of the organization.

Hereinafter, exemplary embodiments of the present disclosure will be described in detail with reference to the accompanying drawings so that those skilled in the art can easily carry out the present disclosure.

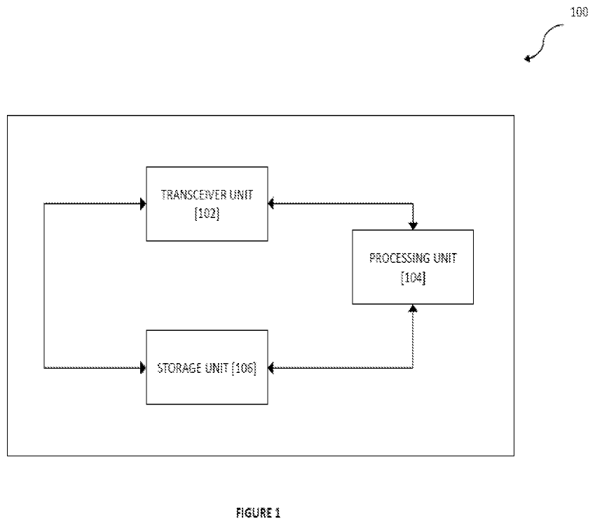

Referring to FIG. 1, an exemplary block diagram of a system [100] for determining market share of an organization is shown. The system [100] comprises at least one transceiver unit [102], at least one processing unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to determine market share of an organization, with the help of the interconnection between the components/units of the system [100].

The transceiver unit [102] is configured to receive at least one of a voice of customer data, an internal data of the organization and an external data. The voice of customer (VoC) data is a user feedback data generated based on a set of social media posts related to one or more organizations. More particularly, to generate the VoC data, in an implementation one or more social media posts from the set of social media posts are firstly categorized into one of a promotional post and non-promotional post. Thereafter irrelevant post(s) are removed from the set of social media posts based at least on a presence of the promotional post and an absence of a customer experience node (such as L1 or L2 customer experience node), in order to further generate the VoC data from the set of social media posts. More particularly, the VoC data is generated based on at least one of an assigned customer experience node of each social media post, an assigned business unit of each social media post, a sentiment of each social media post and the removal of the irrelevant post(s). The VoC data comprises data associated with including but not limited to at least one of a social share of the one or more organization and a social sentiment associated with the one or more organization. In an implementation, the data received as the VoC data is associated with at least one of an organization level, a business unit (BU) level and a BU with Metro (tier) level. Also, in an implementation the VoC data may also be associated with a customer journey node. Furthermore, in an example if an organization is related to e-commerce space, in such scenario a BU may be any business unit such as one of a Mobile, Electronics, Lifestyle, etc., and a customer journey node may be any node related to customer experience such as one of a Delivery, Return, Cancellation, Payment, Customer Care, etc.

The internal data of the organization comprises a data associated with said organization and such data may not be available in public domain. In an example, if an organization is related to an e-commerce space, the internal data may comprise data associated with parameters such as including but not limited to discount, conversion, new customers, event flag, serviceability, etc. Also, in an implementation, the data received as the internal data is associated with at least one of the organization level, the business unit (BU) level and the BU with the Metro level (geographical level).

The external data is a data related to the one or more organizations that is determined based on one or more third party data sources. The external data may comprises a data such as including but not limited to at least one of an application/software install data of the one or more organizations, a top of mind share associated with the one or more organizations, a social media/search-engine trend data of the one or more organizations available at granular levels (such as BU level) and the like. Further, in an implementation if a search interest (i.e. a social-media/search-engine trend data) for one or more topics over one or more search-engines is to be observed for a particular time period, a proportion of the search for said one or more topics may be observed with respect to a highest search volume ever observed for any topic over said one or more search-engines in said particular time period. For instance, if a search interest for a topic ‘ABC’ over a search-engine ‘XYZ’ is to be observed for a time period ‘t’, a proportion of the search for the topic ‘ABC’ is observed with respect to a highest search volume ever observed for any topic (such as for CBA) over the search-engine ‘XYZ’ in said time period ‘t’. More particularly, if ‘CBA’ is the highest searched topic on the search-engine ‘XYZ’ in the time period ‘t’, the search interest for the topic ‘ABC’ over the search-engine ‘XYZ’ in the time period ‘t’ is observed as the proportion of the search for the topic ‘ABC’ with respect to the highest search volume ever observed for the topic ‘CBA’. Therefore, to determine the social media/search-engine trend data of the one or more organizations a volume of searches for one or more topics related to the one or more organizations is considered over a specific period of time.

Also, in an implementation the search engine trend data for any BU of the one or more organizations may be determined based on a list of keywords defined for each of the BU of the one or more organizations. For instance, for a Lifestyle BU associated with an e-commerce platform the keywords may include but not limited to T-shirt, Shirts, jeans, watch, etc. Also, in the given implementation, in order to estimate popularity of a search term/keyword such as ‘jeans’ (i.e. search engine trend data for the search term/keyword such as ‘jeans’) on a digital platform such as ‘B’, the name of said digital platform is appended to said search term/keyword (i.e. jeans+B). Thereafter, a ratio of: 1) a search volume of said search term/keyword with appended digital platform (i.e. jeans+B) on a search engine such as ‘S’; and 2) a sum of the search volume of said search term/keyword with the appended digital platform on said search engine, and a search volume of said search term/keyword with one or more appended digital platforms of competitor organizations (i.e. jeans+C, jeans+D etc.) on said search engine is determined. The said ratio indicates the estimated popularity of said search term/keyword on said digital platform.

Also in an implementation, where to observe a search interest for one or more keywords, a search engine provides a relative number of searches with respect to a highest search volume ever observed from any searched keyword. And where for the search engine it is not possible to compare more than a certain number of keywords (such as 5 keywords) at a same time, one or more groups of keywords (such as one or more group of 4 keywords) may be created to estimate a popularity of a keyword on a digital platform, wherein the group(s) of keywords are further compared with a common keyword. The said common keyword has a highest volume with respect to all other keywords and said common keyword can be a simple keyword like the name of the digital platform. Also, as in each group of keywords a common keyword must have observed a highest volume, a search-engine trend data for all other keywords in said each group of keywords is normalized by same factor. Furthermore, in an implementation, the data received as the external data is associated with at least one of the organization level, the business unit (BU) level and the BU with the Metro level.

Therefore, each of the voice of customer (VoC) data, the internal data of the organization and the external data comprises the data associated at least with at least one of the organization level, the business unit (BU) level and the BU with Metro level.

The transceiver unit [102] is connected to the processing unit [104] and the processing unit [104] is configured to determine one or more set of target features based on at least one of the voice of customer data, the internal data of the organization and the external data. More particularly, to determine the one or more set of target features based on at least one of the voice of customer data, the internal data of the organization and the external data, the processing unit [104], is firstly configured to extract, a set of features from at least one of the voice of customer data, the internal data of the organization and the external data. The set of features comprises one or more features of the one or more organization at, at least one of the organization level, the business unit (BU) level and the BU with Metro level. Also, each feature of the one or more features of the set of features may be one of a competitive feature associated with the one or more organizations or a feature related to an internal metrics of the organization for which the market share is to be determined. Also, in an implementation where the set of features comprises one or more features of the one or more organization at the organization level, one or more competitive features from said one or more features at the organization level may include but not limited to one or more features indicating at least one of a search-engine search, top of mind share, price cost index (CI), VoC data related feature, web analytics and the like. Further, in an implementation where the set of features comprises one or more features of the one or more organization at the BU level, one or more competitive features from said one or more features at the BU level may include but not limited to one or more features indicating at least one of a search-engine search, price cost index (CI), VoC data related feature and the like. Also, in an implementation where the set of features comprises one or more features of the one or more organization at the Metro level, one or more competitive features from said one or more features at the Metro level may include but not limited to one or more features indicating one or more VoC data related features and the like.

Once the set of features is extracted from at least one of the voice of customer data, the internal data of the organization and the external data, the processing unit [104] is further configured to transform, one or more features of the set of features into one or more transformed features. In an implementation the processing unit [104] is configured to transform said one or more features of the set of features by adding at least one of one or more log variables and one or more lag variables. In an implementation all the variables are ratio variables (and not the absolute ones).

Also, the processing unit [104] is thereafter configured to generate, a set of new features based on at least one of the set of features and the one or more transformed features. More particularly, the processing unit [104] is configured to combine two or more features from at least one of the set of features and the one or more transformed features to generate one or more new features. The set of new features comprises the generated one or more new features. For example, a feature from the set of features indicating a net VoC sentiment and a transformed feature from the one or more transformed features indicating a percentage new customers may be combined to generate a new feature.

Further the processing unit [104] is configured to remove, one or more irrelevant features from at least one of the set of features, the one or more transformed features and the set of new features. In an implementation, one or more features from at least one of the set of features, the one or more transformed features and the set of new features are identified as the one or more irrelevant features based on a business understanding for any specific BU, for example installation features for Books & General merchandise (BGM) or lifestyle BU in an e-commerce space. Also, in another implementation, one or more features from at least one of the set of features, the one or more transformed features and the set of new features are identified as the one or more irrelevant features based on a poorer mutual information with a market share variable.

In yet another implementation one or more features from at least one of the set of features, the one or more transformed features and the set of new features are identified as the one or more irrelevant features based on a correlation parameter. More particularly, one or more highly correlated features are identified as the one or more irrelevant features. Also, in an implementation the processing unit [104] is configured to randomly drop the one or more highly correlated features based on a threshold of 90%, to remove said one or more highly correlated (irrelevant) features.

Also, in an implementation ElasticNet may be used as a baseline model, which is just a Linear regression with combined L1 and L2 priors as a regularizer, with a constraint that coefficients can only be positive. So, one or more features whose coefficient should be negative from a business perspective (i.e. the one or more irrelevant features) are negated before dumping them in the model. In an implementation the ElasticNet baseline model is used in Forward selection as well as Permutation importance techniques. The Forward selection is a type of stepwise regression which begins with an empty model and adds in variables one by one. In each forward step, one variable is added that gives a single best improvement to the model. In an implementation, the forward selection technique is performed to get a set of at maximum 10 features. The Permutation feature importance is a model inspection technique that can be used for any fitted estimator when a data is tabular. This is especially useful for non-linear or opaque estimators. The permutation feature importance is defined to be a decrease in a model score when a single feature value is randomly shuffled. This procedure breaks the relationship between a feature and a target, thus the drop in the model score is indicative of how much the model depends on the feature. This technique benefits from being model agnostic and can be calculated many times with different permutations of the feature. The permutation importance function calculates the feature importance of estimators for a given dataset. The n_repeats parameter sets a number of times a feature is randomly shuffled and returns a sample of feature importances. In an implementation, the permutation importance technique is performed until less than 7 features are left or feature importance is more than 0.2% MAE (mean absolute error).

Furthermore, in an implementation the one or more irrelevant features are also removed based on multicollinearity. For instance, Variance inflation factors (VIF) based feature removal techniques may be used to handle multicollinearity. The Variance inflation factors (VIF) range from 1 upwards. The numerical value for VIF provides (in decimal form) what percentage of a variance (i.e. a standard error squared) is inflated for each coefficient. For example, a VIF of 1.9 provides that a variance of a particular coefficient is 90% bigger than the expected in case if there was no multicollinearity—if there was no correlation with other predictors. In an implementation the one or more irrelevant features are removed recursively until the VIF of the individual feature is less than 1000.

Also, in an implementation the one or more irrelevant features are also removed based on p-value. The p-value is used in hypothesis testing to help in supporting or rejecting null hypothesis. The p-value is an evidence against a null hypothesis. The smaller the p-value, the stronger the evidence that the null hypothesis should be rejected. P-values are expressed as decimals although it may be converted to a percentage for better understanding. For example, a p-value of 0.0254 is 2.54%. This means there is a 2.54% chance that a result could be random (i.e. happened by chance). In an implementation, the one or more irrelevant features are removed based on the p-value not unless the one or more irrelevant features have a p-value less than 0.7 (or 70%).

Also, in an implementation the one or more irrelevant features are also removed based on Recursive Feature Elimination and Cross-Validation Selection (RFECV) based feature selection techniques. For instance, the one or more irrelevant features are removed recursively if an importance of the one or more irrelevant features is less than 5% at an individual model level.

Once the one or more irrelevant features are removed, the processing unit [104] is further configured to determine, the one or more set of target features from at least one of the set of features, the one or more transformed features and the set of new features based on the removal of the one or more irrelevant features from at least one of the set of features, the one or more transformed features and the set of new features. More particularly, each set of target features form the one or more set of target features comprises features that are left after removing the one or more irrelevant features from at least one of the set of features, the one or more transformed features and the set of new features. Also, the one or more set of target features are determined at, at least one of the organization level, the business unit (BU) level and the BU with Metro level. Furthermore, each feature/target feature from the one or more set of target features may be one of the competitive feature or the feature related to the internal metrics of the organization. Also, in an implementation where one or more set of target features are determined at the organization level, one or more competitive features from said one or more set of target features at the organization level may include but not limited to the one or more features indicating at least one of the search-engine search, top of mind share, price cost index (CI), VoC data related feature, web analytics and the like. Further, in an implementation where one or more set of target features are determined at the BU level, one or more competitive features from said one or more set of target features at the BU level may include but not limited to the one or more features indicating at least one of the search-engine search, price cost index (CI), VoC data related feature and the like. Also, in an implementation where one or more set of target features are determined at the Metro level, one or more competitive features from said one or more set of target features at the Metro level may include but not limited to the one or more features indicating the one or more VoC data related features and the like.

Further the processing unit [104] is configured to generate, one or more pre-trained dataset based at least on the one or more set of target features. The one or more pre-trained dataset may be generated at, at least one of the organization level, the business unit (BU) level and the BU with Metro level. In an implementation the one or more pre-trained dataset at the organization level are generated based on the one or more set of target features determined at the organization level, the one or more pre-trained dataset at the BU-level are generated based on the one or more set of target features determined at the organization level and the one or more set of target features determined at the BU-level level, and the one or more pre-trained dataset at the BU with Metro level are generated based at least on the one or more set of target features determined at the BU-level (aggregated at the organization level) and the one or more set of target features determined at the BU with Metro level. Also, in an implementation, one or more models are trained based on the one or more pre-trained dataset. Also, the one or more models may be trained using a same base model (for instance the ElasticNet model) at, at least one of the organization level, the business unit (BU) level and the BU with Metro level depending upon the one or more pre-trained dataset used to train such model(s).

Also, in an implementation two or more models trained on different pre-trained datasets may be combined via Stacked Generalization or “Stacking” process to train a meta-model in order to further determine a final prediction of market share of the organization. The Stacked Generalization or “Stacking” for short is an ensemble machine learning technique. It involves combining predictions from multiple machine learning models on a same dataset, like bagging and boosting. Stacking addresses the question: Given multiple machine learning models that are skillful on a problem, but in different ways, how to choose which model to use (trust)? The approach to this question is to use another machine learning model that learns when to use or trust each model in the ensemble. Unlike bagging, in stacking, the models are typically different (e.g. not all decision trees) and fit on the same dataset (e.g. instead of samples of the training dataset). Unlike boosting, in stacking, a single model is used to learn how to best combine predictions from contributing models (e.g. instead of a sequence of models that correct predictions of prior models). The architecture of a stacking model involves two or more base models, often referred to as level-0 models and a meta-model that combines the predictions of the base models referred to as a level-1 model. In an implementation Principal Component Analysis (PCA) technique may be applied on predictions of the level-0 model, which reduces number of input features for the level-1 model without losing much information and therefore it helps the level-1 model to converge faster and make it more robust.

Also, the transceiver unit [102] is further configured to receive, at least one of a first set of feature constraints and a second set of feature constraints. Each of the first set of feature constraints and the second set of feature constraints comprises one or more feature constraints. In an implementation the feature constraint(s) of the first set of feature constraints are different from the feature constraint(s) of the second set of feature constraints. More particularly the feature constraint(s) of the first set of feature constraints does not include feature(s) which cannot be derived to change/predict the market share of the organization. For instance, features associated with the social-media/search-engine trend data cannot be derived. Furthermore, the feature constraint(s) of the first set of feature constraints indicates an importance of one or more features to predict the market share of the organization. Also, the feature constraint(s) of the second set of feature constraints includes one or more features that can improve an accuracy in prediction of the market share of the organization. Hence the feature constraints of the first set of feature constraints are more restrictive than the feature constraint(s) of the second set of feature constraints. In an implementation a Driver model may be trained based on the feature constraint(s) of the first set of feature constraints and an Accurate model may be trained based on the feature constraint(s) of the second set of feature constraints. Also, each of the first set of feature constraints and the second set of feature constraints is defined at, at least one of the organization level, the business unit (BU) level and the BU with Metro level.

The processing unit [104] is thereafter configured to determine the market share of the organization based at least on the one or more pre-trained dataset, the first set of feature constraints and the second set of feature constraints. Also, in an implementation, the market share of the organization may be determined via the Driver model, the Accurate model and one of the one or more models trained based on the one or more pre-trained dataset and the meta-model trained based on the two or more models trained on different pre-trained datasets. Also, the market share of the organization may include but not limited to at least one of a BU market share, metro market share, market share drivers, market share forecast and the like data.

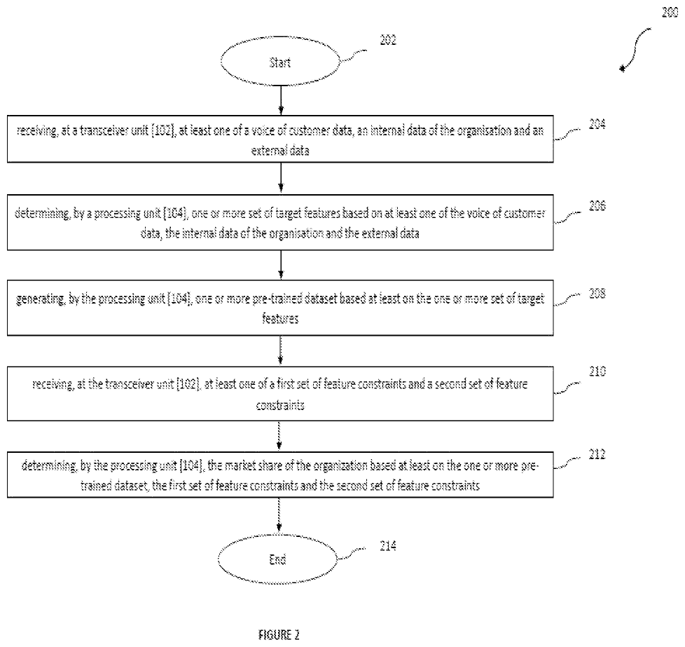

Referring to FIG. 2 an exemplary method flow diagram [200], for determining market share of an organization, in accordance with exemplary embodiments of the present invention is shown. In an implementation the method is performed by the system [100]. Further, in an implementation, the system [100] may be present in a server device to implement the features of the present invention. Also, as shown in FIG. 2, the method starts at step [202].

At step [204] the method comprises receiving, at a transceiver unit [102], at least one of a voice of customer data, an internal data of the organization and an external data. The voice of customer (VoC) data is a user feedback data generated based on a set of social media posts related to one or more organizations. More particularly, to generate the VoC data, in an implementation one or more social media posts from the set of social media posts are firstly categorized into one of a promotional post and non-promotional post. Thereafter irrelevant post(s) are removed from the set of social media posts based at least on a presence of the promotional post and an absence of a customer experience node (such as L1 or L2 customer experience node), in order to further generate the VoC data from the set of social media posts. More particularly, the VoC data is generated based on at least one of an assigned customer experience node of each social media post, an assigned business unit of each social media post, a sentiment of each social media post and the removal of the irrelevant post(s). The VoC data comprises a data associated with including but not limited to at least one of a social share of the one or more organization and a social sentiment associated with the one or more organization. In an implementation, the data received as the VoC data is associated with at least one of an organization level, a business unit (BU) level and a BU with Metro (tier) level. Also, in an implementation the VoC data may also be associated with a customer journey node. Furthermore, in an example if an organization is related to e-commerce space, in such scenario a BU may be any business unit such as one of a Mobile, Electronics, Lifestyle, etc., and a customer journey node may be any node related to customer experience such as one of a Delivery, Return, Cancellation, Payment, Customer Care, etc.

The internal data of the organization comprises a data associated with said organization to predict/determine the market share of the organization and such data may not be available in public domain. Also, in an implementation, the data received as the internal data is associated with at least one of the organization level, the business unit (BU) level and the BU with the Metro level (geographical level).

Further, the external data is a data related to the one or more organizations that is determined based on one or more third party data sources. The external data may comprises a data such as including but not limited to at least one of an application/software install data of the one or more organizations, a top of mind share associated with the one or more organizations, a social media/search engine trend data of the one or more organizations available at granular levels (such as BU level) and the like. Further, in an implementation if a search interest (i.e. a social-media/search-engine trend data) for one or more topics over one or more search-engines is to be observed for a particular time period, a proportion of the search for said one or more topics may be observed with respect to a highest search volume ever observed for any topic over said one or more search-engines in said particular time period. For instance, if a search interest for a topic ‘123’ over a search-engine ‘ABC’ is to be observed for a time period ‘t’, a proportion of the search for the topic ‘123’ is observed with respect to a highest search volume ever observed for any topic (such as for 321) over the search-engine ‘ABC’ in said time period ‘t’. More particularly, if ‘321’ is the highest searched topic on the search-engine ‘ABC’ in the time period ‘t’, the search interest for the topic ‘123’ over the search-engine ‘ABC’ in the time period ‘t’ is observed as the proportion of the search for the topic ‘123’ with respect to the highest search volume ever observed for the topic ‘321’. Therefore, to determine the social media/search-engine trend data of the one or more organizations a volume of searches for one or more topics related to the one or more organizations is considered over a specific period of time.

Also, in an implementation the search engine trend data for any BU of the one or more organizations may be determined based on a list of keywords defined for each of the BU of the one or more organizations. For instance, for a Mobile BU associated with an e-commerce platform the keywords may include but not limited to Mobile, Phone, Headset, etc. Also, in the given implementation, in order to estimate popularity of a search term/keyword such as ‘Phone’ (i.e. search engine trend data for the search term/keyword such as ‘Phone’) on a digital platform such as ‘B’, the name of said digital platform is appended to said search term/keyword (i.e. Phone+B). Thereafter, a ratio of: 1) a search volume of said search term/keyword with appended digital platform (i.e. Phone+B) on a search engine such as ‘A’; and 2) a sum of the search volume of said search term/keyword with the appended digital platform on said search engine, and a search volume of said search term/keyword with one or more appended digital platforms of competitor organizations (i.e. Phone+B, Phone+C etc.) on said search engine is determined. The said ratio indicates the estimated popularity of said search term/keyword on said digital platform.

Also in an implementation, where to observe a search interest for one or more keywords, a search engine provides a relative number of searches with respect to a highest search volume ever observed from any searched keyword. And where for the search engine it is not possible to compare more than a certain number of keywords (such as 5 keywords) at a same time, one or more groups of keywords (such as one or more group of 4 keywords) may be created to estimate a popularity of a keyword on a digital platform, wherein the group(s) of keywords are further compared with a common keyword. The said common keyword has a highest volume with respect to all other keywords and said common keyword can be a simple keyword like the name of the digital platform. Also, as in each group of keywords a common keyword must have observed a highest volume, a search-engine trend data for all other keywords in said each group of keywords is normalized by same factor. Furthermore, in an implementation, the data received as the external data is associated with at least one of the organization level, the business unit (BU) level and the BU with the Metro level.

Therefore, each of the voice of customer (VoC) data, the internal data of the organization and the external data comprises the data associated at least with at least one of the organization level, the business unit (BU) level and the BU with Metro level.

Next at step [206] the method comprises determining, by a processing unit [104], one or more set of target features based on at least one of the voice of customer data, the internal data of the organization and the external data. More particularly, the process/method of the determining, by the processing unit [104], one or more set of target features based on at least one of the voice of customer data, the internal data of the organization and the external data firstly comprises extracting, by the processing unit [104], a set of features from at least one of the voice of customer data, the internal data of the organization and the external data. The set of features comprises one or more features of the one or more organization at, at least one of the organization level, the business unit (BU) level and the BU with Metro level. Also, each feature of the one or more features of the set of features may be one of a competitive feature associated with the one or more organizations or a feature related to an internal metrics of the organization for which the market share is to be determined. Also, in an implementation where the set of features comprises one or more features of the one or more organization at the organization level, one or more competitive features from said one or more features at the organization level may include but not limited to one or more features indicating at least one of a search-engine search, top of mind share, price cost index (CI), VoC data related feature, web analytics and the like. Further, in an implementation where the set of features comprises one or more features of the one or more organization at the BU level, one or more competitive features from said one or more features at the BU level may include but not limited to one or more features indicating at least one of a search-engine search, price cost index (CI), VoC data related feature and the like. Also, in an implementation where the set of features comprises one or more features of the one or more organization at the Metro level, one or more competitive features from said one or more features at the Metro level may include but not limited to one or more features indicating one or more VoC data related features and the like.

Once the set of features is extracted from at least one of the voice of customer data, the internal data of the organization and the external data, the method thereafter leads to transforming, by the processing unit [104], one or more features of the set of features into one or more transformed features. In an implementation the method encompasses transforming by the processing unit [104] said one or more features of the set of features by adding at least one of one or more log variables and one or more lag variables. In an implementation all the variables are ratio variables (and not the absolute ones).

The method thereafter encompasses generating, by the processing unit [104], a set of new features based on at least one of the set of features and the one or more transformed features. More particularly, the method encompasses combining by the processing unit [104] two or more features from at least one of the set of features and the one or more transformed features to generate one or more new features. The set of new features comprises the generated one or more new features. For example, a feature from the set of features indicating a social share and a transformed feature from the one or more transformed features indicating a percentage new customers may be combined to generate a new feature.

Also, the method thereafter comprises removing, by the processing unit [104], one or more irrelevant features from at least one of the set of features, the one or more transformed features and the set of new features. In an implementation, one or more features from at least one of the set of features, the one or more transformed features and the set of new features are identified as the one or more irrelevant features based on a business understanding for any specific BU. Also, in another implementation, one or more features from at least one of the set of features, the one or more transformed features and the set of new features are identified as the one or more irrelevant features based on a poorer mutual information with a market share variable. In yet another implementation one or more features from at least one of the set of features, the one or more transformed features and the set of new features are identified as the one or more irrelevant features based on a correlation parameter. More particularly, one or more highly correlated features are identified as the one or more irrelevant features. Also, in an implementation the method encompasses randomly dropping by the processing unit [104], the one or more highly correlated features based on a threshold of 90%, to remove said one or more highly correlated (irrelevant) features.

Also, in an implementation ElasticNet may be used as a baseline model, which is just a Linear regression with combined L1 and L2 priors as a regularizer, with a constraint that coefficients can only be positive. So, one or more features whose coefficient should be negative from a business perspective (i.e. the one or more irrelevant features) are negated before dumping them in the model. In an implementation the ElasticNet baseline model is used in Forward selection as well as Permutation importance techniques. The Forward selection is a type of stepwise regression which begins with an empty model and adds in variables one by one. In each forward step, one variable is added that gives a single best improvement to the model. In an implementation, the forward selection technique is performed to get a set of at maximum 10 features. The Permutation feature importance is a model inspection technique that can be used for any fitted estimator when a data is tabular. This is especially useful for non-linear or opaque estimators. The permutation feature importance is defined to be a decrease in a model score when a single feature value is randomly shuffled. This procedure breaks the relationship between a feature and a target, thus the drop in the model score is indicative of how much the model depends on the feature. This technique benefits from being model agnostic and can be calculated many times with different permutations of the feature. The permutation importance function calculates the feature importance of estimators for a given dataset. The n_repeats parameter sets a number of times a feature is randomly shuffled and returns a sample of feature importances. In an implementation, the permutation importance technique is performed until feature set is less than 7 or feature importance is more than 0.2% MAE (mean absolute error).

Furthermore, in an implementation the one or more irrelevant features are also removed based on multicollinearity. For instance, variance inflation factors (VIF) based feature removal techniques may be used to handle multicollinearity. The variance inflation factors (VIF) range from 1 upwards. The numerical value for VIF provides (in decimal form) what percentage of a variance (i.e. a standard error squared) is inflated for each coefficient. For example, a VIF of 1.9 provides that a variance of a particular coefficient is 90% bigger than the expected in case if there was no multicollinearity—if there was no correlation with other predictors. In an implementation the one or more irrelevant features are removed recursively until the VIF of the individual feature is less than 1000.

Also, in an implementation the one or more irrelevant features are also removed based on p-value. The p-value is used in hypothesis testing to help in supporting or rejecting null hypothesis. The p-value is an evidence against a null hypothesis. The smaller the p-value, the stronger the evidence that the null hypothesis should be rejected. P-values are expressed as decimals although it may be converted to a percentage for better understanding. For example, a p-value of 0.0342 is 3.42%. This means there is a 3.42% chance that a result could be random (i.e. happened by chance). In an implementation, the one or more irrelevant features are removed based on the p-value not unless the one or more irrelevant features have a p-value less than 0.7 (or 70%).

Also, in an implementation the one or more irrelevant features are also removed based on Recursive Feature Elimination and Cross-Validation Selection (RFECV) based feature selection techniques. For instance, the one or more irrelevant features are removed recursively if an importance of the one or more irrelevant features is less than 5% at an individual model level.

Once the one or more irrelevant features are removed, the method thereafter comprises determining, by the processing unit [104], the one or more set of target features from at least one of the set of features, the one or more transformed features and the set of new features based on the removal of the one or more irrelevant features from at least one of the set of features, the one or more transformed features and the set of new features. More particularly, each set of target features form the one or more set of target features comprises features that are left after removing the one or more irrelevant features from at least one of the set of features, the one or more transformed features and the set of new features. Also, the one or more set of target features are determined at, at least one of the organization level, the business unit (BU) level and the BU with Metro level. Furthermore, each feature/target feature from the one or more set of target features may be one of the competitive feature or the feature related to the internal metrics of the organization. Also, in an implementation where one or more set of target features are determined at the organization level, one or more competitive features from said one or more set of target features at the organization level may include but not limited to the one or more features indicating at least one of the search-engine search, top of mind share, price cost index (CI), VoC data related feature, web analytics and the like. Further, in an implementation where one or more set of target features are determined at the BU level, one or more competitive features from said one or more set of target features at the BU level may include but not limited to the one or more features indicating at least one of the search-engine search, price cost index (CI), VoC data related feature and the like. Also, in an implementation where one or more set of target features are determined at the Metro level, one or more competitive features from said one or more set of target features at the Metro level may include but not limited to the one or more features indicating the one or more VoC data related features and the like.

Further, at step [208] the method comprises generating, by the processing unit [104], one or more pre-trained dataset based at least on the one or more set of target features. The one or more pre-trained dataset may be generated at, at least one of the organization level, the business unit (BU) level and the BU with Metro level. In an implementation the one or more pre-trained dataset at the organization level are generated based on the one or more set of target features determined at the organization level, the one or more pre-trained dataset at the BU-level are generated based on the one or more set of target features determined at the organization level and the one or more set of target features determined at the BU-level level, and the one or more pre-trained dataset at the BU with Metro level are generated based at least on the one or more set of target features determined at the BU-level (aggregated at the organization level) and the one or more set of target features determined at the BU with Metro level. Also, in an implementation, one or more models are trained based on the one or more pre-trained dataset. Also, the one or more models may be trained using a same base model (for instance the ElasticNet model) at, at least one of the organization level, the business unit (BU) level and the BU with Metro level depending upon the one or more pre-trained dataset used to train such model(s).

Also, in an implementation two or more models trained on different pre-trained datasets may be combined via Stacked Generalization or “Stacking” process to train a meta-model in order to further determine a final prediction of market share of the organization. The Stacked Generalization or “Stacking” for short is an ensemble machine learning technique. It involves combining predictions from multiple machine learning models on a same dataset, like bagging and boosting. Stacking addresses the question: Given multiple machine learning models that are skillful on a problem, but in different ways, how to choose which model to use (trust)? The approach to this question is to use another machine learning model that learns when to use or trust each model in the ensemble. Unlike bagging, in stacking, the models are typically different (e.g. not all decision trees) and fit on the same dataset (e.g. instead of samples of the training dataset). Unlike boosting, in stacking, a single model is used to learn how to best combine predictions from contributing models (e.g. instead of a sequence of models that correct predictions of prior models). The architecture of a stacking model involves two or more base models, often referred to as level-0 models and a meta-model that combines the predictions of the base models referred to as a level-1 model. Also, in an implementation Principal Component Analysis (PCA) technique may be applied on predictions of the level-0 model, which reduces number of input features for the level-1 model without losing much information and therefore it helps the level-1 model to converge faster and make it more robust.

Next, at step [210] the method comprises receiving, at the transceiver unit [102], at least one of a first set of feature constraints and a second set of feature constraints. Each of the first set of feature constraints and the second set of feature constraints comprises one or more feature constraints. In an implementation the feature constraint(s) of the first set of feature constraints are different from the feature constraint(s) of the second set of feature constraints. More particularly the feature constraint(s) of the first set of feature constraints does not include feature(s) which cannot be derived to change/predict the market share of the organization. For instance, features associated with the social-media/search-engine trend data cannot be derived. Furthermore, the feature constraint(s) of the first set of feature constraints indicates an importance of one or more features to predict the market share of the organization. Also, the feature constraint(s) of the second set of feature constraints includes one or more features that can improve an accuracy in prediction of the market share of the organization. Hence the feature constraints of the first set of feature constraints are more restrictive than the feature constraint(s) of the second set of feature constraints. In an implementation a Driver model may be trained based on the feature constraint(s) of the first set of feature constraints and an Accurate model may be trained based on the feature constraint(s) of the second set of feature constraints. Also, each of the first set of feature constraints and the second set of feature constraints is defined at, at least one of the organization level, the business unit (BU) level and the BU with Metro level.

Thereafter, at step [212] the method comprises determining, by the processing unit [104], the market share of the organization based at least on the one or more pre-trained dataset, the first set of feature constraints and the second set of feature constraints. Also, in an implementation, the market share of the organization may be determined via the Driver model, the Accurate model and one of the one or more models trained based on the one or more pre-trained dataset, and the meta-model trained based on the two or more models trained on different pre-trained datasets. Also, the market share of the organization may include but not limited to at least one of a BU market share, metro market share, market share drivers, market share forecast and the like data.

After determining the market share of the organization, the method terminates at step [214].

Thus, the present invention provides a novel solution for determining market share of an organization. Also, based on the implementation of the features of the present invention the market share of an organization is predicted effectively and efficiently. Also, the present solution provides a technical advancement over prior known solutions of market share prediction by eliminating the manual efforts in predicting the market share and by providing GMV comparison between competitors at more granular level as compared to the known solutions. Also, the present solution provides a technical effect by providing a solution that can automatically determine market share of public and/or private organizations using data received from various data sources.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for determining market share of an organization, the method comprising:
receiving, at a transceiver unit [102], at least one of a voice of customer data, an internal data of the organisation and an external data;
determining, by a processing unit [104], one or more set of target features based on at least one of the voice of customer data, the internal data of the organisation and the external data;
generating, by the processing unit [104], one or more pre-trained dataset based at least on the one or more set of target features;
receiving, at the transceiver unit [102], at least one of a first set of feature constraints and a second set of feature constraints; and
determining, by the processing unit [104], the market share of the organization based at least on the one or more pre-trained dataset, the first set of feature constraints and the second set of feature constraints.

2. The method as claimed in claim 1, wherein each of the voice of customer data, the internal data of the organisation and the external data comprises a data associated with at least one of an organisation level, a business unit (BU) level and a BU with Metro level.

3. The method as claimed in claim 1, wherein the determining, by a processing unit [104], one or more set of target features based on at least one of the voice of customer data, the internal data of the organisation and the external data further comprises:
extracting, by the processing unit [104], a set of features from at least one of the voice of customer data, the internal data of the organisation and the external data,
transforming, by the processing unit [104], one or more features of the set of features into one or more transformed features,
generating, by the processing unit [104], a set of new features based on at least one of the set of features and the one or more transformed features,
removing, by the processing unit [104], one or more irrelevant features from at least one of the set of features, the one or more transformed features and the set of new features, and
determining, by the processing unit [104], the one or more set of target features from at least one of the set of features, the one or more transformed features and the set of new features based on the removal of the one or more irrelevant features from at least one of the set of features, the one or more transformed features and the set of new features.

4. The method as claimed in claim 3, wherein the one or more set of target features are determined at, at least one of the organisation level, the business unit (BU) level and the BU with Metro level.

5. The method as claimed in claim 1, wherein each of the first set of feature constraints and the second set of feature constraints is defined at, at least one of the organisation level, the business unit (BU) level and the BU with Metro level.

6. A system for determining market share of an organization, the system comprising:
a transceiver unit [102], configured to receive at least one of a voice of customer data, an internal data of the organisation and an external data; and
a processing unit [104], configured to:
determine one or more set of target features based on at least one of the voice of customer data, the internal data of the organisation and the external data, and
generate, one or more pre-trained dataset based at least on the one or more set of target features, wherein:
the transceiver unit [102] is configured to receive, at least one of a first set of feature constraints and a second set of feature constraints, and
the processing unit [104] is configured to determine, the market share of the organization based at least on the one or more pre-trained dataset, the first set of feature constraints and the second set of feature constraints.

7. The system as claimed in claim 6, wherein each of the voice of customer data, the internal data of the organisation and the external data comprises a data associated with at least one of an organisation level, a business unit (BU) level and a BU with Metro level.

8. The system as claimed in claim 6, wherein to determine the one or more set of target features based on at least one of the voice of customer data, the internal data of the organisation and the external data, the processing unit [104], is further configured to:
extract, a set of features from at least one of the voice of customer data, the internal data of the organisation and the external data,
transform, one or more features of the set of features into one or more transformed features,
generate, a set of new features based on at least one of the set of features and the one or more transformed features,
remove, one or more irrelevant features from at least one of the set of features, the one or more transformed features and the set of new features, and
determine, the one or more set of target features from at least one of the set of features, the one or more transformed features and the set of new features based on the removal of the one or more irrelevant features from at least one of the set of features, the one or more transformed features and the set of new features.

9. The system as claimed in claim 8, wherein the one or more set of target features are determined at, at least one of the organisation level, the business unit (BU) level and the BU with Metro level.

10. The system as claimed in claim 6, wherein each of the first set of feature constraints and the second set of feature constraints is defined at, at least one of the organization level, the business unit (BU) level and the BU with Metro level.
